(19) United States
(12) Patent Application Publication
(10) Pub. No.: US 2026/0009713 A1
(43) Pub. Date: Jan. 8, 2026

(54) IN-LIQUID FINE PARITICLE DETECTION DEVICE

(71) Applicant: LG ELECTRONICS INC., Seoul (KR)

(72) Inventor: Jongmyoung PARK, Seoul (KR)

(73) Assignee: LG ELECTRONICS INC., Seoul (KR)

(21) Appl. No.: 19/222,252

(22) Filed: May 29, 2025

(30) Foreign Application Priority Data
Jul. 3, 2024 (KR) 10-2024-0087656
Oct. 14, 2024 (WO) PCT/KR2024/015450

(51) Int. Cl. G01N 15/075; G01N 15/00; G01N 15/0205

(52) U.S. Cl. CPC G01N 15/075; G01N 15/0211; G01N 2015/0053

(57) ABSTRACT

An in-liquid fine particle detection device including a flow channel through which a solution flows; an optical shielding surrounding the flow channel; a light source arranged on a light input side of the optical shielding and configured to emit light into an inside of the optical shielding surrounding the flow channel; a stray light prevention structure arranged on a light output side of the optical shielding and configured to remove light emitted by the light source and propagated through the flow channel; and a scattering detector arranged between the light source and the stray light prevention structure and configured to detect scattered light, resulting from the emitted light scattered by fine particles included in the solution flowing in the flow channel.

### CROSS-REFERENCE TO RELATED APPLICATION

This application claims the benefit under 35 U.S.C. § 119 (a) to Korean Patent Application No. 10-2024-0087656, filed on Jul. 3, 2024, and to International Patent Application No. PCT/KR2024/015450, filed on Oct. 14, 2024, all of which are incorporated by reference into the present application.

### BACKGROUND

### Field

The present disclosure relates to an in-liquid fine particle detection device. More particularly, the present disclosure relates to a turbidimeter that is an in-liquid fine particle detection device in home appliances, such as purifiers or washing machines.

### Description of the Related Art

In-liquid fine particle detection devices are for measuring light scattered by particles suspended in liquids and can be referred to as turbidimeters. These turbidimeters need to be manufactured with a size and price suitable for mounting in home appliances, such as purifiers, dishwashers, and washing machines. In addition, the turbidimeters need to manufactured as real-time sensors for measuring fine particles in real-time in-home appliances.

In more detail, to detect and receive scattered light, a detector is arranged on the lateral portion of a vial, and light is directed onto the lower end portion of the vial. In this configuration, a liquid sample is introduced through the vial's inlet port. However, because the vial does not have an outlet port, a problem arises in that real-time measurements cannot be conducted. In addition, directing light onto the lower end portion of the vial and arranging the detector on the lateral portion of the vial pose problems in product commercialization, such as reduced assimilability and higher costs.

Further, although not scattered by particles in a solution within the vial, light emitted by a light source is reflected or scattered from the internal surface of a body structure of the device, thereby being directed onto the detector and becoming stray light. This stray light resulting from light being reflected or scattered from the internal surface of the body structure decreases the detection precision for fine particles within a solution, such as water.

### SUMMARY

Accordingly, one object of the present disclosure is to provide an in-liquid fine particle detection device that is manufactured with a size or price suitable for mounting in home appliances, such as purifiers, dishwashers, and washing machines.

Another object of the present disclosure is to enhance the detection precision for in-liquid fine particles though a stray light prevention structure that prevents a decrease in the detection precision for in-liquid fine particles due to stray light occurring within the body of an in-liquid fine particle detection device.

Still another object of the present disclosure is to provide an in-liquid fine particle detection device capable of conducting real-time measurements through a pipe-shaped flow passage pipe with a light incident inlet port and a light emission outlet port.

In order to achieve these and other advantages and in accordance with the purpose of this specification, as embodied and broadly described herein, there is provided an in-liquid fine particle detection device including a flow channel through which a solution flows; an optical shielding surrounding the flow channel and configured to block external light; a light source arranged on one side of the optical shielding and configured to emit light into the inside of the optical shielding; a stray light prevention structure arranged on the opposite side of the optical shielding and configured to remove light emitted by the light source and propagating through the flow channel; and a scattering detector arranged between the light source and the stray light prevention structure and configured to detect scattered light, resulting from the emitted light reacting with fine particles.

According to an embodiment, in the in-liquid fine particle detection device, a surface normal vector, which is a vector perpendicular to the plane surface of an inlet end of the stray light prevention structure, can be arranged in the direction of pointing toward the optical axis of incident light propagating through the flow channel and entering the stray light prevention structure.

According to an embodiment, in the in-liquid fine particle detection device, the stray light prevention structure can be formed so the inlet end thereof has a rectangular shape. The stray light prevention structure can be formed so a surface area of the inlet end thereof is greater than a second surface area, to which light propagating through the flow channel is emitted, of the opposite side of the optical shielding.

According to an embodiment, in the in-liquid fine particle detection device, the stray light prevention structure can include a wall surface that reflects or absorbs, one or more times, light emitted by the light source.

According to an embodiment, in the in-liquid fine particle detection device, the wall surface of the stray light prevention structure can include a first wall surface formed at a first angle with respect to the inlet end, thereby absorbing or reflecting light; and a second wall surface formed at a second angle with respect to the inlet end, thereby absorbing or reflecting light.

According to an embodiment, in the in-liquid fine particle detection device, the stray light prevention structure can be formed so the first wall surface thereof has the first angle ranging between 20 degrees and 45 degrees. The stray light prevention structure can be formed so the second wall surface thereof has the second angle ranging between 0 degrees and 90 degrees.

According to an embodiment, in the in-liquid fine particle detection device, one end portion of the first wall surface can be coupled to the upper end, along a Y-axis, of the opposite side of the optical shielding. Also, one end portion of the second wall surface can be coupled to the lower end, along the Y-axis, of the opposite side of the optical shielding. The one end portion of the second wall surface 420, which is adjacent to the opposite side of the optical shielding, can be formed to be in parallel with a Z-axis.

8. According to an embodiment, in the in-liquid fine particle detection device, the stray light prevention structure can be made from the same mechanical member as the optical shielding. The surface reflection rate of the stray light prevention structure can range between 0% and 40%.

According to an embodiment, in the in-liquid fine particle detection device, light emitted by the light source has a wavelength band ranging from 200 nm to 1300 nm.

According to an embodiment, in the in-liquid fine particle detection device, the flow channel can be formed to have a circular or rectangular pipe through which the solution is enabled to flow.

According to an embodiment, in the in-liquid fine particle detection device, the circular or rectangular pipe of the flow channel can be formed of transparent glass or plastic material that permits light transmission.

According to an embodiment, in the in-liquid fine particle detection device, the flow channel can be formed so a first distance from the flow channel to the one side of the optical shielding, on which the light source is arranged, is greater than a second distance from the flow channel to the opposite side of the optical shielding, on which the stray light prevention structure is arranged.

According to an embodiment, in the in-liquid fine particle detection device, the scattering detector can be formed so a third distance from the scattering detector to the one side of the optical shielding, on which the light source is arranged, is greater than a fourth distance from the scattering detector to the opposite side of the optical shielding, on which the stray light prevention structure is arranged. The flow channel and the scattering detector can be formed so the centers thereof along a Z-axis are the same. The flow channel and the scattering detector can be formed so a first length, along the Z-axis, of the flow channel is greater than a second length, along the Z-axis, of the scattering detector.

According to an embodiment, in the in-liquid fine particle detection device, the optical shielding can be formed in a hexahedral shape. The light source can be formed in such a manner as to be inserted by a first length L1 into a first surface that is one lateral surface of the optical shielding and to be exposed over a second length L2 outward from the first surface. The stray light prevention structure can be formed on a second surface that is the opposite lateral surface of the optical shielding.

According to an embodiment, in the in-liquid fine particle detection device, the light source can be formed to have a first diameter in the XY plane and YZ plane of the first surface. The flow channel can be formed to have a second diameter, greater than the first diameter, in the YZ plane.

According to an embodiment, in the in-liquid fine particle detection device, the stray light prevention structure can be formed so an end portion of the first wall surface thereof protrudes farther than the scattering detector, so that light propagating through the flow channel is reflected ten times or more from the first wall surface and the second wall surface.

According to an embodiment, in the in-liquid fine particle detection device, the scattering detector can be formed on a third surface between the first surface and the second surface. The scattering detector can be formed in such a manner as to be inserted by a third length L3 into the third surface and to be exposed over a fourth length L4 outward from the third surface.

According to an embodiment, in the in-liquid fine particle detection device, the flow channel can be formed in a first cylindrical shape. The optical shielding can be formed in a second cylindrical shape in such a manner as to surround the flow channel. A first slot region having a first slot length can be formed on the one side of the optical shielding. A second slot region having a second slot length can be formed on the opposite side of the optical shielding. The second slot length can be greater than the first slot length.

According to at least one of the embodiments, light that is emitted by the light source and becomes stray light can be removed through the stray light prevention structure, thereby ensuring a high detection rate for fine particles.

According to at least one of the embodiments, while a measurement-target solution is continuously provided through the flow passage pipe, fine particles in the fresh solution can be measured, thereby enabling real-time measurement of fine particles suspended in the solution.

According to at least one of the embodiments, since the flow channel is arranged adjacent to the stray light prevention structure, starting from the center of the optical shielding, light propagating through the flow channel can be effectively collected by the stray light prevention structure, thereby effectively suppressing the occurrence of stray light.

According to at least one of the embodiments, since the flow channel is arranged to be spaced a predetermined distance or more away from the center of the optical shielding toward the light source, light emitted by the light source can propagate through all regions of the flow channel. Therefore, fine particles within the flow channel can be effectively detected.

According to at least one of the embodiments, the shape and size of each constituent element of the in-liquid fine particle detection device can be determined taking into consideration a spectrum distribution of incident light and emitted light.

According to at least one of the embodiments, the in-liquid fine particle detection device, configured to include the light source, the scattering detector, the stray light prevention structure, and the optical shielding, can provide not only a high detection rate, but also achieve lightweight, thin, small-sized, and compact characteristics, low cost, and high productivity.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a lateral view illustrating an in-liquid fine particle detection device according to the present disclosure;

FIG. 2 is a plan view illustrating the in-liquid fine particle detection apparatus according to the present disclosure;

FIG. 3 is a conceptual diagram that is referenced to describe a phenomenon where light propagating through a flow channel in the in-liquid fine particle detection device is reflected from within an optical shielding, thereby becoming stray light;

FIGS. 4 and 5 are plan views, each illustrating the in-liquid fine particle detection device including a stray light prevention structure that is formed at a predetermined angle with respect to the opposite side of the optical shielding;

FIG. 6 is a plan view illustrating the in-liquid fine particle detection device including the optical shielding in a hexahedral shape, and the light source and the scattering detector, one region of each of which is inserted into the internal region of the optical shielding;

FIG. 7 is a perspective view illustrating the in-liquid fine particle detection device according to the present disclosure;

FIG. 8 includes graphs illustrating an irradiance distribution on a first planar surface of one side of a flow channel.

FIG. 9 includes graphs illustrating an irradiance distribution on a second planar surface of the opposite side of the flow channel; and

FIG. 10 includes plan views, each illustrating the in-liquid fine particle detection device including the optical shielding that is formed in a manner that corresponds to the shape of the flow channel.

### DETAILED DESCRIPTION OF THE EMBODIMENTS

It should be noted that the technical terms used herein are for the purpose of describing specific embodiments only and are not intended to limit the disclosure. The singular forms are intended to include the plural forms as well, unless the context clearly indicates otherwise. Suffixes “module” and “part” used for components used in the following description are merely intended for easy description of the specification, and each suffix itself is not intended to give any special meaning or function.

In this specification, the terms “including” or “being configured to” should not be construed to necessarily include all of the components or steps described in the specification, and some of the components or steps may not be included, or can include additional components or steps.

In describing the embodiments disclosed herein, moreover, the detailed description will be omitted when a specific description for publicly known technologies to which the disclosure pertains is judged to obscure the gist of the disclosure.

The accompanying drawings are used to help easily understand various technical features, and it should be understood that the embodiments presented herein are not limited by the accompanying drawings. As such, the disclosure should be construed to extend to any alterations, equivalents, and substitutes in addition to those which are particularly set forth in the accompanying drawings. In addition, it should be understood that not only the embodiments described below but also combinations of embodiments can be included within the technical idea and scope of the disclosure as modifications, equivalents, or substitutes.

An in-liquid fine particle detection device according to the present disclosure is described below. In this regard, to detect and receive scattered light, a detector is arranged on the lateral portion of a vial, and light is directed onto the lower end portion of the vial. In this configuration, a liquid sample is introduced through the vial's inlet port. However, because the vial does not have an outlet port, a problem arises in that real-time measurements cannot be conducted. In addition, arranging the detector on the lateral portion and directing light onto the lower end portion of a flow passage can pose problems in product commercialization, such as reduced assimilability and higher costs.

In addition, even when no light is scattered by particles suspended in a solution within the vial, light emitted by a light source can be reflected or scattered by the internal surface of the device's body structure and is directed onto the scattering detector, thereby becoming stray light. Stray light resulting from light being reflected or scattered from the internal surface of the body structure decreases the detection precision for fine particles within a solution, such as water.

One object of the present disclosure is to provide an in-liquid fine particle detection device that is manufactured as being mountable on home appliances, such as water purifiers, dishwashers, and washing machines. Another object of the present disclosure is to enhance the detection precision for in-liquid fine particles though a stray light prevention structure that prevents a decrease in the detection precision for in-liquid fine particles due to stray light occurring within the body of an in-liquid fine particle detection device. Still another object of the present disclosure is to provide an in-liquid fine particle detection device capable of conducting real-time measurements through a pipe-shaped flow channel with a light incident inlet port and a light emission outlet port.

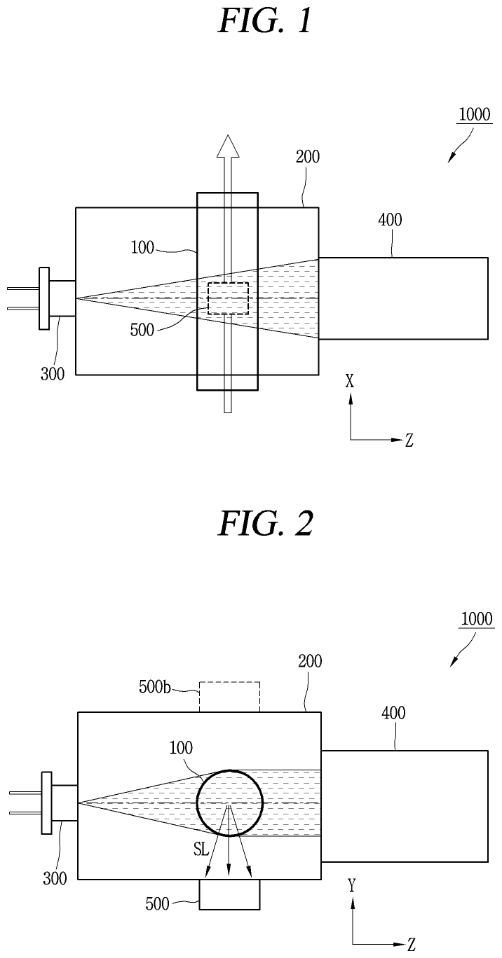

An in-liquid fine particle detection device according to the present disclosure, which is provided to accomplish the above-mentioned objects, is described with reference to the drawings. In this regard, FIG. 1 is a lateral view illustrating the in-liquid fine particle detection device according to the present disclosure, and FIG. 2 is a plan view illustrating the in-liquid fine particle detection apparatus according to the present disclosure.

With reference to FIG. 1, a flow channel 100 can be formed to have a rectangular cross section in the XY plane. Solutions, such as water, can flow through the internal region of the flow channel 100, along the X-axis direction, of the flow channel 100. Therefore, the in-liquid fine particle detection device according to the present disclosure can be configured to detect fine particles in solutions, such as water, within respective flow channels of purifiers, washing machines, and the like.

An optical shielding 200 can be formed to block external light to precisely detect fine particles within the flow channel 100. A light source 300 can be arranged on one side of the optical shielding 200. Light emitted by the light source 300 can propagate through the flow channel 100, forming a predetermined light angle range along the X-axis direction, thereby enabling detection of fine particles within the flow channels 100.

A stray light prevention structure 400 can be arranged on the opposite side of the optical shielding 200. The stray light prevention structure 400 prevents the occurrence of stray light by removing light that propagates through the flow channel 100 and is reflected from within the optical shielding 200. Light from the light source 300 can be emitted to a specific position, along the X-axis, on the flow channel 100. When light is emitted to the specific position on the flow channel 100, scattered light can occur by fine particles or similar substances within the flow channel 100. A scattering detector 500 can be arranged to detect scattered light at the specific position, along the X-axis, on the flow channel 100.

With reference to FIG. 2, the flow channel 100 can be formed to have a circular cross section in the YZ plane. Light emitted by the light source 300 can propagate through the flow channel 100 along the Z-axis direction, thereby enabling detection of fine particles within the flow channel 100. In addition, light can be emitted along the Y-axis direction of the flow channel 100 to the entire internal region of the flow channel 100. Therefore, the in-liquid fine particle detection device according to the present disclosure can be configured to detect fine particles in solutions, such as water, within respective flow channels of purifiers, washing machines, and the like.

The optical shielding 200 can be formed to block external light to precisely detect fine particles within the flow channel 100. The light source 300 can be arranged on the one side of the optical shielding 200. Light emitted by the light source 300 can propagate through the flow channel 100, forming a predetermined light angle range along the Y-axis direction, thereby enabling detection of fine particles within the flow channels 100.

The stray light prevention structure 400 can be arranged on the opposite side of the optical shielding 200. The stray light prevention structure 400 prevents the occurrence of stray light by removing light that propagates through the flow channel 100 and is reflected from within the optical shielding 200. The scattering detector 500 can be arranged on the lower end of the optical shielding 200 to detect scattered light SL that occurs due to fine particles or similar substances within the flow channel 100.

In this regard, the position of the scattering detector 500 is not limited to the lower end of the optical shielding 200. The scattering detector 500 can be arranged to be positioned at an arbitrary position on the optical shielding 200 rather than at a position on the light source 300 or the stray light prevention structure 400. A scattering detector 500b can be arranged on the upper end of the optical shielding 200.

A plurality of scattering detectors 500 and a plurality of scattering detectors 500b can also be arranged on the lower end and upper end, respectively, of the optical shielding 200. The distribution of fine particles in the lower region and upper region of the flow channel 100 can be acquired by comparing fine particles detected through the scattering detectors 500 and 500b.

With reference to FIGS. 1 and 2, an in-liquid fine particle detection device 1000 according to the present disclosure is described. The in-liquid fine particle detection device 1000 according to the present disclosure can include the flow channel 100, shaped like a flow passage pipe, and the optical shielding 200 that surrounds the flow channel 100. The in-liquid fine particle detection device 1000 according to the present disclosure can include the light source 300 that utilizes a semiconductor light source, such as a LED or LD, with a wavelength ranging from 200 nm to 1300 nm.

The in-liquid fine particle detection device 1000 according to the present disclosure can include the stray light prevention structure 400 arranged on the opposite side of the light source 300, with the flow channel 100 in between. The scattering detector 500 of the in-liquid fine particle detection device 1000 according to the present disclosure can be arranged at an arbitrary position in the direction of radiation from the center of the flow channel 100 rather than in a region where the light source 300 and the stray light prevention structure 400 are arranged.

The in-liquid fine particle detection device 1000 according to the present disclosure can be configured with a minimal number of components, including the flow channel 100, the optical shielding 200, the light source 300, the stray light prevention structure 400, and the scattering detector 500. The in-liquid fine particle detection device 1000 according to the present disclosure is significantly advantageous in terms of manufacturing and assembling processes, minimization, and low costs. In addition, the in-liquid fine particle detection device 1000 according to the present disclosure has a structure that enables a measurement-target solution to flow through the flow channel 100, shaped like a flow passage pipe, thereby enabling real-time measurement of fine particles suspended in the solution. In addition, the stray light prevention structure 500 is arranged in the in-liquid fine particle detection device 1000 according to the present disclosure, thereby providing a high detection rate for fine particles.

As described above, the in-liquid fine particle detection device 1000 can be configured to include the flow channel 100, the optical shielding 200, the light source 300, the stray light prevention structure 400, and the scattering detector 500. The flow channel 100 can be formed to allow a solution to flow through the internal region thereof. The flow channel 100 can be formed as a flow passage pipe with a predetermined diameter, but is not limited to this form. The optical shielding 200 can be formed to surround the flow channel 100. The optical shielding 200 can be configured to block external light.

The light source 300 can be arranged on the one side of the optical shielding 200. The light source 300 can be configured to emit light into the inside of the optical shielding 200. The light source 300 can be formed to emit light in a wavelength band from 200 nm to 1300 nm.

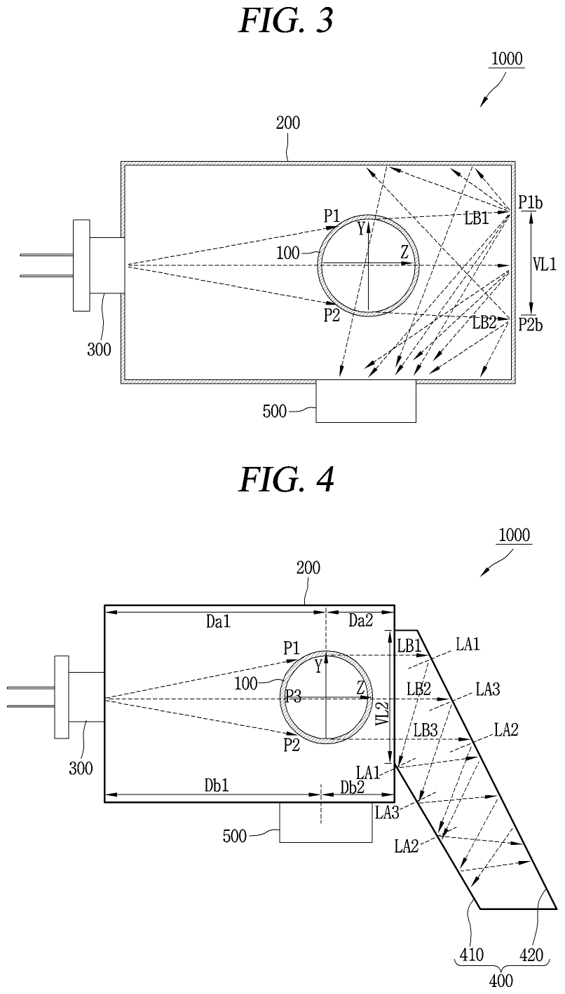

The stray light prevention structure 400 can be arranged on the opposite side of the optical shielding 200. The stray light prevention structure 400 can be configured to remove light that is emitted by the light source 300 and propagates through the flow channel 100. In this regard, FIG. 3 is a conceptual diagram that is referenced to describe a phenomenon where light propagating through the flow channel in the in-liquid fine particle detection device is reflected from within the optical shielding, thereby becoming stray light.

With reference to FIGS. 1 to 3, the stray light prevention structure 400 and the scattering detector 500 of the in-liquid fine particle detection device 1000 according to the present disclosure are described. The stray light prevention structure 400 can be configured to remove light that is emitted by the light source 300 and propagates through the flow channel 100.

The stray light prevention structure 400 can be formed to absorb a first light beam LB1 propagating through a first point P1 within the upper region, in the YZ plane, of the flow channel 100, or to guide the first light beam LB1 toward a region outside the optical shielding 200. Accordingly, the first light beam LB1 can be prevented from becoming stray light in an internal region of the optical shielding 200.

The stray light prevention structure 400 can be formed to absorb a second light beam LB2 propagating through a second point P2 within the lower region, in the YZ plane, of the flow channel 100, or to guide second light beam LB2 toward a region outside the optical shielding 200. Accordingly, the second light beam LB2 can be prevented from becoming stray light in the internal region of the optical shielding 200.

The stray light prevention structure 400 can be formed to absorb a third light beam LB3 propagating through a third point P3, in the YZ plane, of the flow channel 100, or to guide the third light beam LB3 toward a region outside the optical shielding 200. Accordingly, the third light beam LB3 can be prevented from becoming stray light in the internal region of the optical shielding 200.

Therefore, the stray light prevention structure 400 can be formed to have a first perpendicular length VL1 or greater in such a manner as to absorb the first and second light beams LB1 and LB2 that propagate through the first and second points P1 and P2, respectively, in the YZ plane, within the flow channel 100. In this regard, the stray light prevention structure 400 can be formed to absorb light propagating through the flow channel 100 or to guide the light toward a region outside the optical shielding 200. The stray light prevention structure 400 can be configured to absorb or guide light in a region indicated by the first perpendicular length VL1 for the removal thereof. Accordingly, the stray light prevention structure 400 can be referred to as a light guide part or a light removal part.

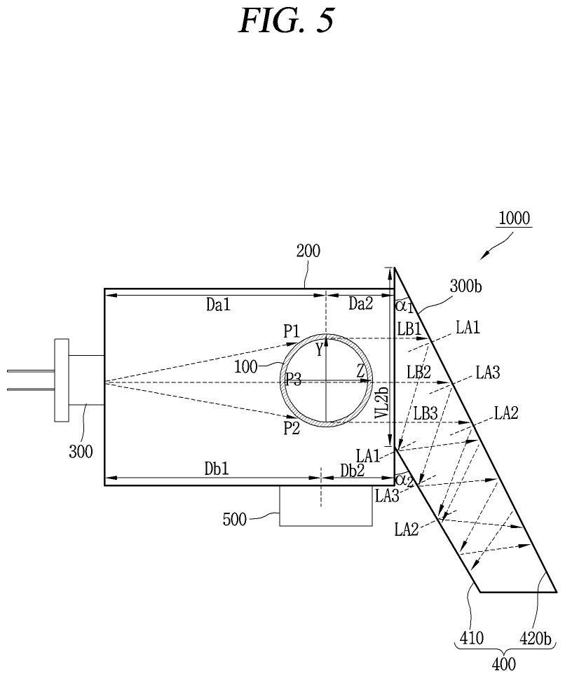

The stray light prevention structure 400 according to the present disclosure can be formed at a predetermined angle with respect to the opposite side of the optical shielding 200 in such a manner as to absorb light propagating through the flow channel 100 or to guide the light toward a region outside the optical shielding 200. Therefore, the stray light prevention structure 400 in the in-liquid fine particle detection device 1000 according to the present disclosure can be formed to have an inclined structure. In this regard, FIGS. 4 and 5 are plan views, each illustrating the in-liquid fine particle detection device including the stray light prevention structure that is formed at a predetermined angle with respect to the opposite side of the optical shielding.

With reference to FIG. 4, the stray light prevention structure 400 can be configured to include a first wall surface 410 and a second wall surface 420. The first wall surface 410 and the second wall surface 420 can be formed to be inclined at predetermined angles, respectively, with respect to the opposite side of the optical shielding 200.

One end portion of the first wall surface 410 and one end portion of the second wall surface 420 can be coupled to the opposite side of the optical shielding 200. The one end portion of the first wall surface 410 can be coupled to the lower end, along the Y-axis, of the opposite side of the optical shielding 200. The one end portion of the second wall surface 420 can be coupled to the upper end, along the Y-axis, of the opposite side of the optical shielding 200.

Therefore, the second wall surface 420 of the stray light prevention structure 400 can be formed so the one end portion thereof is coupled to the upper end of the opposite side of the optical shielding 200. In this regard, the second wall surface 420 adjacent to the opposite side of the optical shielding 200 can be formed to be in parallel with the Z-axis.

With reference to FIG. 5, the stray light prevention structure 400 can be configured to include the first wall surface 410 and a second wall surface 420b. The first wall surface 410 and the second wall surface 420b can be formed to be inclined at first and second angles α₁ and α₂, respectively, with respect to the opposite side of the optical shielding 200. The optical shielding 200 can be formed so the length thereof along the Y-axis direction is equal to or greater than a predetermined length. Alternatively, the optical shielding 200 can be coupled to a separate plate. Accordingly, the stray light prevention structure 400 can be formed so one end portion of the second wall surface 420b thereof is coupled to the opposite side of the optical shielding 200 at the second angle α2 with respect thereto.

With reference to FIGS. 1 to 5, the stray light prevention structure 400 can be arranged so an inlet end thereof is perpendicular to incident light that propagates through the flow channel 100 and enters the stray light prevention structure 400. A surface normal vector at an inlet end of the stray light prevention structure is arranged in the direction of pointing toward the optical axis of incident light propagating through the flow channel and entering the stray light prevention structure. The surface normal vector is defined as a vector perpendicular to the plane surface.

With reference to FIGS. 4 and 5, the inlet end of the stray light prevention structure 400 can be perpendicular to first incident light resulting from the first light beam LB1 that propagates through the first point P1 on the flow channel 100. At this point, a first optical axis of first reflection light serves as a reflection reference LA1 for the first wall surface 410 and the second wall surface 420 or 420b. The first reflection light is reflected according to the law of reflection. The inlet end of the stray light prevention structure 400 can be perpendicular to second incident light resulting from second light beam LB2 that propagates through the second point P2 on the flow channel 100. At this point, a second optical axis of second reflection light serves as a reflection reference LA2 for the first wall surface 410 and the second wall surface 420 or 420b. The second reflection light is reflected according to the law of reflection. The inlet end of the stray light prevention structure 400 can be perpendicular to third incident light resulting from the third light beam LB3 that propagates through the third point P3 within the flow channel 100. At this point, a third optical axis of third reflection light serves as a reflection reference LA3 for the first wall surface 410 and the second wall surface 420 or 420b. The first reflection light is reflected according to the law of reflection.

The stray light prevention structure is formed so an end portion of the first wall surface 410 thereof protrudes farther along the Y-axis direction than the scattering detector 500, so that light propagating through the flow channel 100 is reflected ten times or more from the first wall surface 410 and the second wall surface 420.

With reference to FIGS. 1 to 5, the scattering detector 500 can be arranged between the light source 300 and the stray light prevention structure 400. The scattering detector 500 can be configured to detect scattered light that results from light emitted by the light source 300 reacting with fine particles.

With reference to FIGS. 1 to 5, the stray light prevention structure 400 can be formed so the inlet end thereof has a rectangular shape. The stray light prevention structure 400 can be formed so a surface area of the inlet end thereof is greater than a second surface area, to which light propagating through the flow channel 100 is emitted, of the opposite side of the optical shielding 200. In this regard, the stray light prevention structure 400 can be formed so a second perpendicular length VL2 or VL2b of the inlet end thereof is greater than the first perpendicular length VL1 between the first and second light beams LB1 and LB2. The first perpendicular length VL1 corresponds to a length between first and second points P1b and P2b, to which the first and second light beams LB1 and LB2 propagating through the flow channel 100 are respectively emitted, on the opposite side of the optical shielding 200.

The stray light prevention structure 400 can include a wall surface (indicated by a combination of 410 and 420) that reflects or absorbs, one or more times, light emitted by the light source 300. The wall surface of the stray light prevention structure 400 is configured to include the first wall surface 410 and the second wall surface 420 or 420b.

Light that is emitted by the light source 300 and then propagates through the flow channel 100 can enter the stray light prevention structure 400. Accordingly, the stray light prevention structure 400 can be formed to have a small-sized and simple structure, allowing light propagating through the flow channel 100 to enter the stray light prevention structure 400 and disappear therein.

Light that propagates through a focal point of the light source 300 and then the flow channel 100 is reflected by the second wall surface 420 or 420b of the stray light prevention structure 400 and subsequently by the first wall surface 410 of the stray light prevention structure 400. Reflection by the first wall surface 410 of the stray light prevention structure 400 and subsequently by the second wall surface 420 or 420b can be repeated. For example, reflection within the stray light prevention structure 400 can occur 10 times or more, but is not limited to this number. The number of times of reflection can vary depending on the application.

The internal surfaces of the first wall surface 410 and the second wall surface 420 or 420b of the stray light prevention structure 400 can be made from light absorption members. When the stray light prevention structure 400 has an absorption rate of 95% (a reflection rate of 5%) and the number of times of reflection therein is 10, the reflection rate is reduced to 9.77×10⁻¹⁴, thereby achieving a very excellent stray light removal performance of nearly 100% absorption. Even when the stray light prevention structure 400 has an absorption rate of 80% (a reflection rate of 20%) and the number of times of reflection therein is 5, the reflection rate is reduced to 0.00032, thereby achieving an excellent stray light removal performance of 99.97% absorption.

The first wall surface 410 can be formed at the first angle α₁ with respect to the inlet end of the stray light prevention structure 400, thereby absorbing or reflecting light. The second wall surface 420 can be formed at the second angle α₂ with respect to the inlet end of the stray light prevention structure 400, thereby absorbing or reflecting light.

The first wall surface 410 can be formed to have the first angle α₁ ranging between 20 degrees and 45 degrees. In this regard, when the first angle α₁ of the first wall surface 410 is smaller than 20 degrees, a plurality of light beams, including the first light beam LB1, can become stray light due to irregular reflection of the plurality of light beams. When the first angle α₁ of the first wall surface 410 is greater than 45 degrees, the degree to which the stray light prevention structure 400 protrudes along the Z-axis direction increases.

The second wall surface 420 can be formed to have the second angle α₂ ranging between 0 degrees and 90 degrees. In this regard, the second angle α₂ of the second wall surface 420 has less influence on the degree to which a plurality of reflected light beams propagate downward along the Y-axis than the first angle α₁ of the first wall surface 410. However, when the second angle α₂ of the second wall surface 420 is smaller than 20 degrees, an issue with the process of forming the second wall surface 420 can occur. In addition, when the second angle α₂ of the second wall surface 420 is smaller than 20 degrees, interference with scattered light detected by the scattering detector 500 can occur.

The stray light prevention structure 400 can be made from the same mechanical member as the optical shielding 200. The stray light prevention structure 400 can be formed so the surface reflection rate of the stray light prevention structure 400 ranges between 0% and 40%.

The flow channel 100 can be formed to have a circular or rectangular pipe inside, through which a solution is enabled to flow. The flow channel 100 can be configured so the circular or rectangular pipe of the flow channel 100 is formed of transparent glass or plastic material that permits light transmission.

In this regard, the fine particle detection device according to the present disclosure is configured to detect fine particles in liquid solutions, such as water. In this regard, the fine particle detection device is technically distinguished by the ability thereof to detect fine particles in liquids, such as water, rather than gases, such as air.

In this regard, among fluids, gases, such as air, and liquids, such as water, differ in viscosity. Air has a refractive index of 1.0 and water has a refractive index of 1.333. Thus, they exhibit entirely distinct optical characteristics. Therefore, the fine particle detection device according to the present disclosure that detects fine particles in liquids using an optical technique has a different configuration than a detection device for detecting fine dust and microorganisms in air.

A device for detecting fine particles in gases, such as air, focuses light at the center of a flow channel. In contrast, the in-liquid fine particle detection device according to the present disclosure does not separately include a constituent element that focuses light within the flow channel 100, thereby exhibiting an entirely distinct optical configuration.

Light is not focused within the flow channel 100 in the in-liquid fine particle detection device according to the present disclosure. Consequently, a large surface area for light emission can be widely formed in the flow channel 100 where light scattering can occur. In addition, the flow channel 100 can be configured so light scattering can occur throughout all regions of the flow channel 100 by making the size of the flow channel smaller than the surface area for light emission.

The flow channel 100 can be formed to have an offset structure where the flow channel 100 is spaced apart in one direction from the center, along the Z-axis direction, of the optical shielding 200. The flow channel 100 can be formed so a first distance Da1 from the center thereof to the one side of the optical shielding 200 is greater than a second distance Da2 from the center thereof to the opposite side of the optical shielding 200. In this regard, the light source 300 can be arranged on the one side of the optical shielding 200. The stray light prevention structure 400 can be arranged on the opposite side of the optical shielding 200.

Since the flow channel 100 is arranged adjacent to the stray light prevention structure 400, starting from the center, along the Z-axis, of the optical shielding 200, light propagating through the flow channel 100 is effectively collected by the stray light prevention structure 400, thereby effectively suppressing the occurrence of stray light. In addition, since the flow channel 100 is arranged to be spaced a predetermined distance or more apart from the center, along the Z-axis, of the optical shielding 200 toward the light source 300, light emitted by the light source 300 can propagate through all regions of the flow channel 100. Therefore, fine particles within the flow channel 100 can be effectively detected.

The scattering detector 400 can be formed to have an offset structure where the scattering detector 400 is spaced apart in one direction from the center, along the Z-axis direction, of the optical shielding 200. Specifically, the scattering detector 400 can be formed so a third distance Db1 from the center thereof to the one side of the optical shielding 200 is greater than a fourth distance Db2 from the center thereof to the opposite side of the optical shielding 200. In this regard, the light source 300 can be arranged on the one side of the optical shielding 200. The stray light prevention structure 400 can be arranged on the opposite side of the optical shielding 200.

The flow channel 100 and the scattering detector 400 can be formed so the centers thereof along the Z-axis are the same. The flow channel 100 and the scattering detector 400 can be formed so a first length, along the Z-axis, of the flow channel 100 is greater than a second length, along the Z-axis, of the scattering detector 400. Accordingly, scattered light, resulting from light emitted by the light source 300 being scattered by fine particles within the flow channel 100, can be detected precisely. In addition, light scattered by fine particles through all regions of the flow channel 100 can be detected by the scattering detector 400.

Since the flow channel 100 is arranged adjacent to the stray light prevention structure 400, starting from the center, along the Z-axis, of the optical shielding 200, light propagating through the flow channel 100 is effectively collected by the stray light prevention structure 400, thereby effectively suppressing the occurrence of stray light. In addition, the flow channel 100 is arranged to be spaced a predetermined distance or more from the center, along the Z-axis, of the optical shielding 200 toward the light source 300. Therefore, light emitted by the light source 300 can propagate through all regions of the flow channel 100. Accordingly, fine particles within the flow channel 100 can be effectively detected.

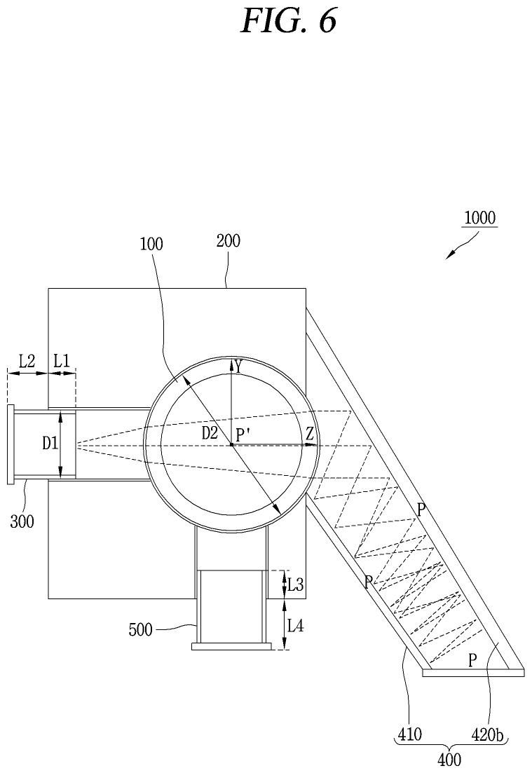

The optical shielding of the in-liquid fine particle detection device according to the present disclosure can also be formed in a hexahedral shape or another configuration. In this regard, the light source, and the scattering detector of the in-liquid fine particle detection device according to the present disclosure can be formed in a cylindrical shape so one region of each of the light source and the scattering detector is inserted into the internal region of the optical shielding. In this regard, FIG. 6 is a plan view illustrating the in-liquid fine particle detection device including the optical shielding in a hexahedral shape, and the light source and the scattering detector, one region of each of which is inserted into the internal region of the optical shielding.

With reference to FIGS. 1 to 6, the optical shielding 200 can be formed in a hexahedral shape. The light source 300 can be inserted by a first length L1 into a first surface that is one lateral surface of the optical shielding 200. The light source 300 can be formed in such a manner as to be exposed over a second length L2 outward from the first surface that is one lateral surface of the optical shielding 200. The stray light prevention structure 400 can be formed on a second surface that is the opposite lateral surface of the optical shielding 200.

The light source 300 can be formed to have a first radius R1 in the XY plane and YZ plane of the first surface of the optical shielding 200. The flow channel 100 can be formed to have a second radius, as an external diameter thereof, that is greater than the first radius R1 in the YZ plane. The flow channel 100 can be formed so the first light beam LB1 and the second light beam LB2, emitted by the light source 300 and propagating along a light angle border, come into contact with the first point P1 and the second point P2, respectively, on the internal border of the flow channel 100. Therefore, a first diameter D1 of the light source 300 can be set to a value within a predetermined range so a predetermined ratio or more of light propagates through the flow channel 100.

When the first diameter D1 of the light source 300 is below a first threshold value, light propagates through only one region of the flow channel 100. Consequently, fine particles cannot be detected through all regions of the flow channel 100. In contrast, the first diameter D1 of the light source 300 exceeds a second threshold value, the ratio of emitted light propagating to a region outside the flow channel 100 exceeds a specific ratio. Light propagating to a region outside the flow channel 100 can be detected by the scattering detector 500, but scattered light exceeding a predetermined ratio may not be detected.

When the first diameter D1 of the light source 300 exceeds the second threshold value, the intensity of light propagating through the inside of the flow channel 100 decreases. Accordingly, to precisely detect fine particles within the flow channel 100, it is necessary to increase the intensity of light emitted to the light source 300. Accordingly, the first diameter D1 of the light source 300 can be set to a value between the first threshold value and the second threshold value.

The scattering detector 500 can be formed on a third surface between the first surface and the second surface of the optical shielding 200. The scattering detector 500 can be formed in such a manner as to be inserted by a third length L3 into the third surface of the optical shielding 200 and be exposed over a fourth length L4 outward from the third surface.

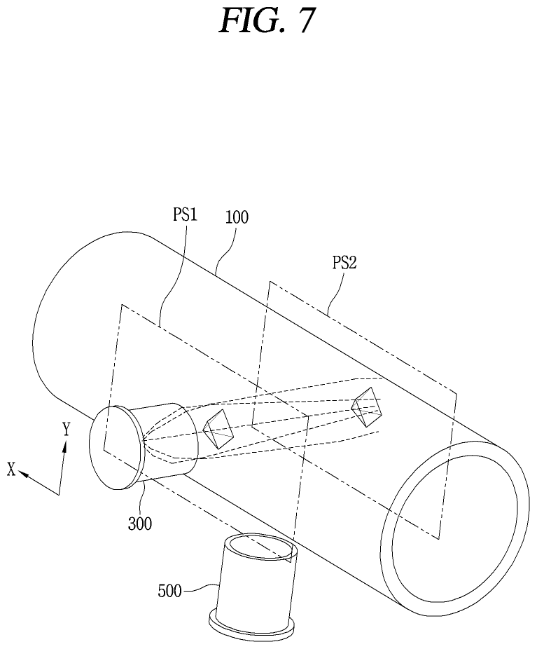

The shape and size of each constituent element of the in-liquid fine particle detection device can be determined taking into consideration a spectrum distribution of incident light and emitted light. In this regard, FIG. 7 is a perspective view illustrating the in-liquid fine particle detection device according to the present disclosure.

With reference to FIG. 7, the in-liquid fine particle detection device 100 can be formed in a cylindrical shape that has a predetermined length in the X-axis direction and a circular shape in the YZ plane. The light source 300 can be arranged to be spaced apart from one side of the flow channel 100. The scattering detector 500 can be arranged to be spaced apart from the lower region of the flow channel 100.

With reference to FIGS. 6 and 7, the light source 300 can be arranged to be spaced apart from the one side of the flow channel 100. The light source 300 can be formed on the one side of the optical shielding 200. Light emitted by the light source 300 can form an irradiance distribution, that is, a specific distribution, on a first planar surface PS1 of the one side of the flow channel 100. Light propagating through the flow channel 100 can form an irradiance distribution, that is, a specific distribution, on a second planar surface PS2 of the opposite side of the flow channel 100.

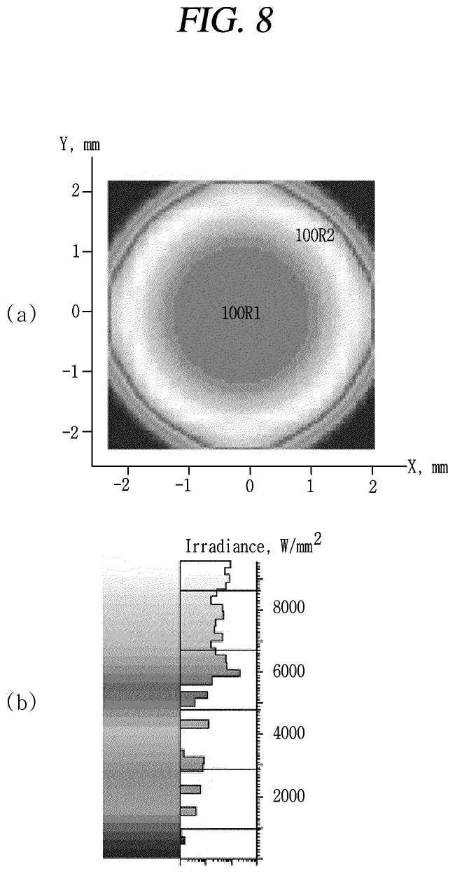

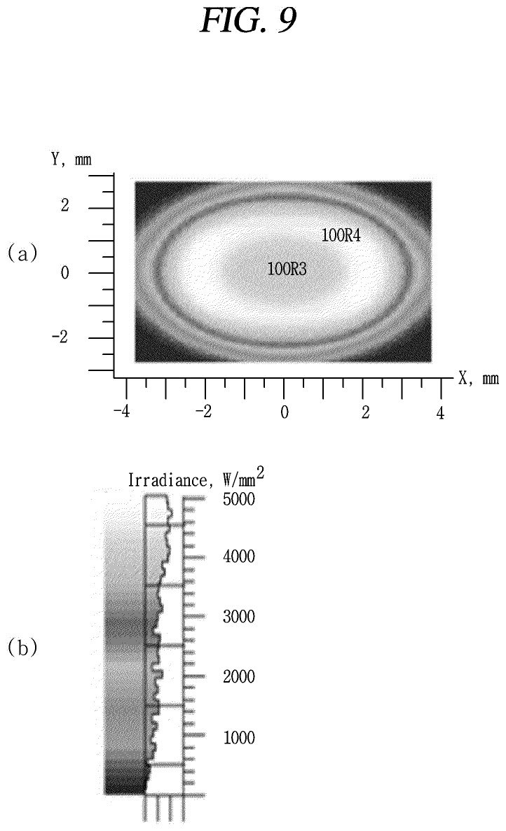

In this regard, FIGS. 8(a) and (b) are graphs, each illustrating the irradiance distribution on the first planar surface of the one side of the flow channel, and FIGS. 9(a) and (b) are graphs, each illustrating the irradiance distribution on the second planar surface on the opposite side of the flow channel. FIG. 8(a) illustrates the irradiance distribution on the first planar surface of the one side of the flow channel, and FIG. 8(b) illustrates the intensity values of the irradiance distribution formed on the flow channel in FIG. 8(a). FIG. 9(a) illustrates the irradiance distribution on the second planar surface of the opposite side of the flow channel, and FIG. 9(b) illustrates intensity values within the irradiance distribution formed on the flow channel in FIG. 9(a).

With reference to FIG. 6, FIG. 7, and FIGS. 8(a) and (b) the irradiance distribution on the first planar surface PS1 of the one side of the flow channel 100 has a circular shape that shares the same center as the light source 300.

With reference to FIG. 6, FIG. 7, and FIGS. 9(a) and (b), the irradiance distribution on the second planar surface PS2 of the opposite side of the flow channel 100 has an elliptical shape that shares the same center as the light source 300. As light emitted by the light source 300 propagates through the flow channel 100, the value of irradiance on the opposite side of the flow channel 100 decreases. Therefore, the value of irradiance on the second planar surface PS2 of the opposite side of the flow channel 100 becomes lower than the value of irradiance on the first planar surface PS1 of the one side of the flow channel 100.

In association with the irradiance distribution in an elliptical shape, the water within the flow channel 100 and the flow channel 100, shaped like a flow passage pipe, can operate as a cylinder lens. The inlet end of the stray light prevention structure 400, corresponding to a light emission portion of the flow channel 100, needs to be formed in such a shape that the inlet end thereof encompasses an irradiance distribution range and thus accommodates all light emitted from the flow channel 100, shaped like a flow passage pipe. Therefore, the inlet end of the optical shielding 200, corresponding to the light emission portion of the flow channel 100, has an elliptical or rectangular shape.

In this regard, the stray light prevention structure 400 can be formed so the inlet end thereof has a first length, along the X-axis direction, of the flow channel 100 and a second length, smaller than the first length, along the Y-axis direction. The stray light prevention structure 400 can be formed so the inlet end thereof has the first length along the X-axis that is approximately twice as large as the second length along the Y-axis. For example, the stray light prevention structure 400 can be formed so the inlet end thereof has a length of 8 mm along the X-axis direction of the flow channel 100 and a length of 4 mm along the Y-axis direction. However, these lengths are variable depending on the application.

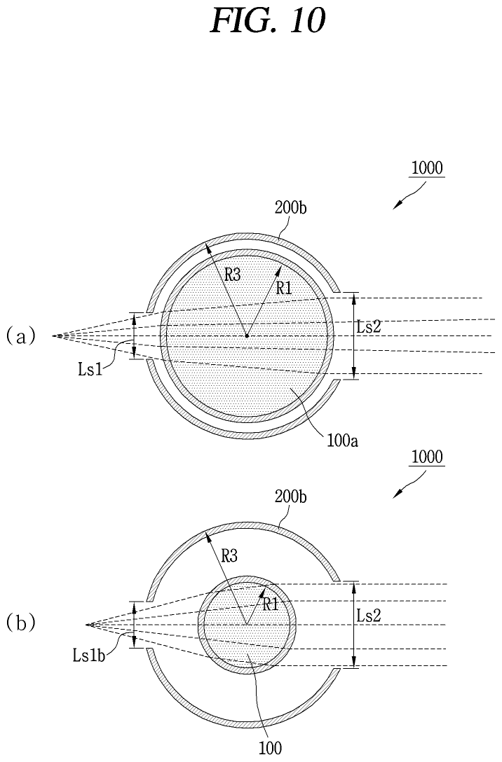

The optical shielding according to the present disclosure can be formed in a manner that corresponds to the shape of the flow channel. In this regard, FIGS. 10(a) and (b) are plan views, each illustrating the in-liquid fine particle detection device including the optical shielding that is formed in a manner that corresponds to the shape of the flow channel.

With reference to FIG. 10(a), a flow channel 100a can be formed in a first cylindrical shape with a first radius R1. An optical shielding 200b can be formed in a second cylindrical shape in such a manner as to surround the flow channel 100a. One region of the flow channel 100a can be illuminated with a plurality of light beams emitted by the light source. Accordingly, fine particles may not be detected throughout all regions of the flow channel 100. However, irregular reflection, scattering, and similar effects caused by the plurality of light beams emitted by the light source and external light can be prevented.

A first slot region having a first slot length Ls1 can be formed on the one side of the optical shielding 200 so the light source is arranged on the one side of the optical shielding 200. A second slot region having a second slot length Ls2 can be formed on the opposite side of the optical shielding 200 so the stray light prevention structure is arranged on the opposite side of the optical shielding 200.

With reference to FIG. 10(b), the flow channel 100 can be formed in the first cylindrical shape with the second radius R2. The flow channel 100 can be formed so the second radius R2 is smaller than the first radius R1 of the flow channel 100a in FIG. 10(a). The optical shielding 200b can be formed in the second cylindrical shape in such a manner as to surround the flow channel 100. The flow channel 100 can be formed to have the second radius R2 so all regions of the flow channel 100a is illuminated with the plurality of light beams emitted by the light source. Accordingly, fine particles can be effectively detected throughout all regions of the flow channel 100.

The first slot region having a first slot length Ls1b can be formed on the one side of the optical shielding 200 so the light source is arranged on the one side of the optical shielding 200. The first slot region in FIG. 10(b) can be formed so the first slot length Ls1b thereof is smaller than a first slot length Ls1a of the first slot region in FIG. 10(a).

In this regard, the first slot length Ls1b of the first slot region can also be dynamically adjusted depending on the second radius R2 of the flow channel 100, the transparency of a solution within the flow channel 100, and the detection precision for fine particles. Therefore, light can be emitted to the entire flow channel 100a or 100 by changing the distance between the light source 300 and the flow channel 100a or 100 and the diameter of the flow channel 100a or 100, thereby enhancing the detection performance for fine particles.

The second slot region having the second slot length Ls2 can be formed on the opposite side of the optical shielding 200 so the stray light prevention structure is arranged on the opposite side of the optical shielding 200.

With reference to FIGS. 10(a) and (b), the in-liquid fine particle detection device 1000 can be configured to include the flow channel 100a or 100 and the optical shielding 200b.

With reference to FIGS. 10(a) and (b), the flow channel 100a or 100 can be formed in the first cylindrical shape with the second radius R2. The optical shielding 200b can be formed in the second cylindrical shape with a third radius R3 in such a manner as to surround the flow channel 100. The first slot region with the first slot length Ls1 can be formed on one side of the optical shielding 200b. The second slot region with the second slot length Ls2 can be formed on the opposite side of the optical shielding 200b.

The second slot region can be formed so the second slot length Ls2 thereof is greater than the first slot length Ls1 on the one side of the optical shielding 200b. Light can be emitted to all regions of the flow channel 100 with the second radius R2 by setting the first slot length Ls1 to a first threshold value or higher. Unnecessary light scattering within the optical shielding 200b can be reduced by setting the first slot length Ls1 to the second threshold value or lower.

In contrast, the second slot length Ls2 of the opposite side of the optical shielding 200b can be set to a third threshold value or higher so light propagating through all regions of the flow channel 100 is introduced. The second slot length Ls2 can be set to a fourth threshold value or lower so light scattered outside the flow channel 100 is not introduced.

The in-liquid fine particle measurement device according to the present disclosure is described above. The technical effects of the in-liquid fine particle measurement device according to the present disclosure are summarized as follows. However, the in-liquid fine particle measurement device is not limited to these technical effects. These technical effects can be changed depending on the application.

According to at least one of the embodiments, light that is emitted by the light source and becomes stray light can be removed through the stray light prevention structure, thereby ensuring a high detection rate for fine particles.

According to at least one of the embodiments, while a measurement-target solution is continuously provided through the flow passage pipe, fine particles in the fresh solution can be measured, thereby enabling real-time measurement of fine particles suspended in the solution.

According to at least one of the embodiments, since the flow channel is arranged adjacent to the stray light prevention structure, starting from the center of the optical shielding, light propagating through the flow channel can be effectively collected by the stray light prevention structure, thereby effectively suppressing the occurrence of stray light.

According to at least one of the embodiments, since the flow channel is arranged to be spaced a predetermined distance or more away from the center of the optical shielding toward the light source, light emitted by the light source can propagate through all regions of the flow channel. Therefore, fine particles within the flow channel can be effectively detected.

According to at least one of the embodiments, the shape and size of each constituent element of the in-liquid fine particle detection device can be determined taking into consideration a spectrum distribution of incident light and emitted light.

According to at least one of the embodiments, the in-liquid fine particle detection device, configured to include the light source, the scattering detector, the stray light prevention structure, and the optical shielding, can provide not only a high detection rate, but also achieve lightweight, thin, small-sized, and compact characteristics, low cost, and high productivity.

The disclosure can be implemented as computer-readable codes in a program-recorded medium. The computer-readable media can include all kinds of recording apparatuses in which data readable by a computer system is stored. Examples of the computer-readable medium include a hard disk drive (HDD), a solid-state disk (SSD), a silicon disk drive (SDD), a ROM, a RAM, a CD-ROM, a magnetic tape, a floppy disk, an optical data storage device and the like, and can also be implemented in the form of a carrier wave (e.g., transmission over the Internet).

Therefore, the detailed description should not be limitedly construed in all of the aspects, and should be understood to be illustrative. The scope of the disclosure should be determined by reasonable interpretation of the appended claims and all changes that come within the equivalent scope of the disclosure are included in the scope of the disclosure.

What is claimed is:

1. An in-liquid fine particle detection device comprising:
a flow channel through which a solution flows;
an optical shielding surrounding the flow channel;
a light source arranged on a light input side of the optical shielding and configured to emit light into an inside of the optical shielding surrounding the flow channel;
a stray light prevention structure arranged on a light output side of the optical shielding and configured to remove light emitted by the light source and propagated through the flow channel; and
a scattering detector arranged between the light source and the stray light prevention structure and configured to detect scattered light, resulting from the emitted light scattered by fine particles included in the solution flowing in the flow channel.

2. The in-liquid fine particle detection device of claim 1, wherein the stray light prevention structure has an inlet surface facing the light propagating through the flow channel and perpendicular to an optical axis of incident light propagating through the flow channel and entering the stray light prevention structure.

3. The in-liquid fine particle detection device of claim 2, wherein the inlet surface of the stray light prevention structure has a rectangular shape greater in size than a second surface area corresponding to the light propagating through the flow channel.

4. The in-liquid fine particle detection device of claim 2, wherein the stray light prevention structure includes a wall surface that reflects or absorbs, one or more times, light emitted by the light source.

5. The in-liquid fine particle detection device of claim 4, wherein the wall surface of the stray light prevention structure comprises:
a first wall surface formed at a first angle with respect to the inlet surface, thereby absorbing or reflecting light; and
a second wall surface formed at a second angle with respect to the inlet surface, thereby absorbing or reflecting light.

6. The in-liquid fine particle detection device of claim 5, wherein the first angle of the first wall surface is between 20 degrees and 45 degrees, and the second angle of the second wall surface is between 0 degrees and 90 degrees.

7. The in-liquid fine particle detection device of claim 6, wherein an upper end portion of the first wall surface is coupled to an upper end, along a Y-axis, of the optical shielding,
wherein an upper end portion of the second wall surface is coupled to a lower end, along the Y-axis, of the light output side of the optical shielding, and
wherein the upper end portion of the second wall surface, which is adjacent to the light output side of the optical shielding, is in parallel with a Z-axis.

8. The in-liquid fine particle detection device of claim 1, wherein the stray light prevention structure includes a same mechanical member as the optical shielding, and
wherein a surface reflection rate of the stray light prevention structure ranges between 0% and 40%.

9. The in-liquid fine particle detection device of claim 1, wherein light emitted by the light source has a wavelength band ranging from 200 nm to 1300 nm.

10. The in-liquid fine particle detection device of claim 1, wherein the flow channel has a circular or rectangular pipe through which the solution flows.

11. The in-liquid fine particle detection device of claim 10, wherein the circular or rectangular pipe of the flow channel includes transparent glass or plastic material.

12. The in-liquid fine particle detection device of claim 1, wherein a first distance from the flow channel to the light input side of the optical shielding, on which the light source is arranged, is greater than a second distance from the flow channel to the light output side of the optical shielding, on which the stray light prevention structure is arranged.

13. The in-liquid fine particle detection device of claim 12, wherein a third distance from the scattering detector to the light input side of the optical shielding, on which the light source is arranged, is greater than a fourth distance from the scattering detector to the light output side of the optical shielding, on which the stray light prevention structure is arranged,
wherein centers of the flow channel and the scattering detector along a Z-axis are the same, and
wherein a first length, along the Z-axis, of the flow channel is greater than a second length, along the Z-axis, of the scattering detector.

14. The in-liquid fine particle detection device of claim 5, wherein the optical shielding has a hexahedral shape,
wherein the light source is inserted by a first length into light input side of optical shielding and is exposed over a second length outward from the light input side of the optical shielding, and
wherein the stray light prevention structure is formed on light output side of the optical shielding.

15. The in-liquid fine particle detection device of claim 14, wherein the light source has a first diameter in the XY plane and YZ plane of the first surface, and
wherein the flow channel has a second diameter, greater than the first diameter, in the YZ plane.

16. The in-liquid fine particle detection device of claim 14, wherein an end portion of the stray light prevention structure protrudes below a bottom surface of the scattering detector, so that light propagating through the flow channel is reflected ten times or more between the first wall surface and the second wall surface of the stray light prevention structure.

17. The in-liquid fine particle detection device of claim 14, wherein the scattering detector is formed on a bottom surface between the light input side and light output side of the optical shielding, and
wherein the scattering detector is inserted by a third length into the bottom surface and is exposed over a fourth length outward from the bottom surface.

18. The in-liquid fine particle detection device of claim 1, wherein the flow channel has a first cylindrical shape,
wherein the optical shielding has a second cylindrical shape surrounding the flow channel,
wherein the light input side of the optical shielding has a first slot region having a first slot length, and
wherein the light output side of the optical member has a second slot region having a second slot length greater than the first slot length.
